(19) United States
(12) Patent Application Publication
(10) Pub. No.: US 2003/0169906 A1
(43) Pub. Date: Sep. 11, 2003

(54) Method and apparatus for recognizing objects

(76) Inventors: Salih Burak Gokturk, Mountain View, CA (US); Abbas Rafii, Palo Alto, CA (US); James D. Spare, San Francisco, CA (US)

Correspondence Address: HICKMAN PALERMO TRUONG & BECKER, LLP, 1600 WILLOW STREET, SAN JOSE, CA, 95125, US

(21) Appl. No.: 10/375,345

(22) Filed: Feb. 26, 2003

Related U.S. Application Data
(60) Provisional application No. 60/360,137, filed on Feb. 26, 2002.
(60) Provisional application No. 60/382,550, filed on May 22, 2002.
(60) Provisional application No. 60/424,662, filed on Nov. 7, 2002.

(51) Int. Cl. G06K 9/00; G06K 9/46

(52) U.S. Cl. 382/115; 382/190; 382/224

(57) ABSTRACT

Objects may be recognized through various levels of recognition using a combination of senors and algorithms such as described herein. In order to perform recognition, a depth distance or range is obtained for each surface region in a plurality of surface regions that form a viewable surface of the object that is to be recognized. An identification for the plurality of surface regions.

### RELATED APPLICATION AND PRIORITY INFORMATION

This application claims benefit of priority to:

Provisional U.S. Patent Application No. 60/360,137, entitled “Passive, Low-Impact, Keyless Entry System,” naming James Spare as inventor, filed on Feb. 26, 2002;

Provisional U.S. Patent Application No. 60/382,550, “Detection of faces from Depth Images,” naming Salih Burak Gokturk and Abbas Rafii as inventors, filed on May 22, 2002;

Provisional U.S. Patent Application No. 60/424,662, “Provisional: Methods For Occupant Classification,” naming Salih Burak Gokturk as inventor, filed on Nov. 7, 2002

All of the aforementioned priority applications are hereby incorporated by reference in their entirety for all purposes.

### FIELD OF THE INVENTION

The present invention relates to an interface for electronic devices. In particular, the present invention relates to a light-generated input interface for use with electronic devices.

### BACKGROUND OF THE INVENTION

Various approaches have been offered to the problems of occupant (person) classification, face detection and face recognition. These approaches have had mixed-success.

There are many patents for the classification of the occupant type and head location in an automobile. For example, in U.S. Pat. No. 5,983,147, a video camera is used to determine if the front right seat is empty, occupied by a Rear-Facing Infant Seat (RFIS), or occupied by a person. The image processing included histogram equalization followed by principal component analysis based classification. This patent uses intensity images as input.

In U.S. Pat. No. 6,005,958, an occupant type and position detection system is described. The system uses a single camera mounted to see both the driver and passenger-side seats. The area of the camera's view is lit by an infrared (IR) light-emitting diode (LED). The patent provides for rectifying an image with a correction lens to make the image look as if it were taken from the side of the vehicle. Occupant depth is determined by a defocus technique. An occupancy grid is generated, and compared to “stored profiles” of images that would be obtained with an empty seat, a person, or a child. The patent mentions that a “size-invariant classification of reference features” must be used to allow for shape and size variations, but offers no detail on this very difficult and open problem in computer vision. A description on the classification algorithm, or how features are compared to stored profiles, is lacking in this patent.

In U.S. Pat. Nos. 6,422,595, 6,412,813 and 6,325,414, an occupant's position and velocity are obtained through use of various types of sensors. One IR transmitter and two IR receivers are located on the instrument panel. The transmitter rays reflect from windshield and reflect from the occupant to be received by the two receivers. The reflections are used to estimate the occupant's position. The manner in which pattern recognition is implemented is not a focus of the patent.

In U.S. Pat. No. 6,111,517, a continuous monitoring system for regulating access to a computer system or other restricted environment is disclosed. The system employs real-time face recognition to initially detect the presence of an authorized individual and to grant the individual access to the computer system. While the patent does mention the use of depth sensors for this task, few details are provided on use of a recognition system.

U.S. Pat. No. 6,108,437 describes a system for face detection and recognition. The system uses two-dimensional intensity images as input. It employs face detection by ambient light normalization followed by downsampling and template matching. Once the face is detected, the two-dimensional face image is aligned using the locations of the eyes. The recognition is accomplished using feature extraction followed by template matching.

In U.S. Pat. No. 5,835,616, Lobo et al describes a face detection method using templates. The described method is a two-step process for automatically finding a human face from a two-dimensional intensity image, and for confirming the existence of the face by examining facial features. One disclosed step is to detect the human face. This step is accomplished in stages that include enhancing the digital image with a blurring filter and edge enhancer in order to better set forth the unique facial features such as wrinkles, and curved shapes of a facial image. Another step is to confirm the existence of the human face in seven stages by finding facial features of the digital image encompassing the chin, sides of the face, virtual top of the head, eyes, mouth and nose of the image. Ratios of the distances between these found facial features are compared to previously stored reference ratios for recognition.

In U.S. Pat. Nos. 5,842,194 and 5,802,208, two systems that use intensity images are described. The first one of these methods uses a linear discriminant analysis on a fuzzy combination of multiple resolutions. The second one of these methods uses discrete cosine transformation based features. Both of these methods utilize two-dimensional image input.

U.S. Pat. No. 6,463,163 describes a face detection system and a method of pre-filtering an input image for face detection utilizing a candidate selector that selects candidate regions of the input image that potentially contains a picture of a human face. The candidate selector operates in conjunction with an associated face detector that verifies whether the candidate regions contain a human face. The linear and non-linear filters that are used are described.

### SUMMARY OF THE INVENTION

According to embodiments of the invention, objects may be recognized through various levels of recognition using a combination of sensors and algorithms such as described herein. In one embodiment, a depth distance or range is obtained for each surface region in a plurality of surface regions that form a viewable surface of the object that is to be recognized. An identification feature of at least a portion of the object is determined using the depth information for the plurality of surface regions.

The type of recognition that can be employed includes classifying the object as belonging to a particular category, detecting the object from other objects in a region monitored by sensors, detecting a portion of the object from a remainder of the object, and determining an identity of the object.

### DESCRIPTION OF THE DRAWINGS

Embodiments of the invention are illustrated by way of example, and not by way of limitation, in the figures of the accompanying drawings. Like reference numerals are intended to refer to similar elements among different figures.

FIG. 1 illustrates a system for recognizing objects, under an embodiment of the invention.

FIG. 2 illustrates components for use with a recognition system, under an embodiment of the invention.

FIG. 3A illustrates an output of a light-intensity sensor.

FIG. 3B illustrates an output of a depth perceptive sensor.

FIG. 4 illustrates a method for classifying an object using depth information, under an embodiment of the invention.

FIG. 5A illustrates a difference image before morphological processing is applied for classifying an object.

FIG. 5B illustrates a difference image after morphological processing is applied for classifying an object.

FIG. 6 illustrates a down-sampled image for use with an embodiment such as described with FIG. 4.

FIG. 7 illustrates a method for detecting a person's face, under an embodiment of the invention.

FIG. 8 illustrates a method where depth information about the position of the object of interest is used indirectly to supplement traditional identity algorithms that use light-intensity images for recognition, under an embodiment of the invention.

FIG. 9 illustrates a method where a depth image is used to directly determine the identity of a person, under an embodiment of the invention.

FIG. 10 illustrates one embodiment of an application for identifying a person based on the person's face.

FIG. 11 illustrates an application for a passive security system, under an embodiment of the invention.

### DETAILED DESCRIPTION OF THE INVENTION

Embodiments of the invention describe a method and apparatus for recognizing objects. In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

A. Overview

According to embodiments of the invention, objects may be recognized through various levels of recognition using a combination of sensors and algorithms such as described herein. In one embodiment, a depth distance or range is obtained for each surface region in a plurality of surface regions that form a viewable surface of the object that is to be recognized. An identification feature of at least a portion of the object is determined using the depth information for the plurality of surface regions.

In an embodiment, a depth perceptive sensor may be used to obtain the depth information. The depth perceptive sensor captures a depth image that can be processed to determine the depth information.

According to one embodiment, the identification feature that is determined using the depth information includes one or more features that enables the object to be classified in a particular category. In another embodiment, the identification feature includes one or more features for detecting the object from other objects in a particular scene. Still further, another embodiment provides that identification features are determined from the depth information in order to determine an identity of the object.

Applications are also provided that require classifying, detecting, and determining the identity of an object. For example, a passive keyless entry system is described that enables a person to gain access to a locked area simply by standing in front of a sensor and having his face recognized.

Embodiments such as described have particular application to classifications of people versus other objects, facial detection, and facial recognition.

B. Terminology

The term “image” means an instance of light recorded on a tangible medium. The image does not have to be a recreation of the reflection, but merely record a characteristic of a scene, such as depth of surfaces in the scene, or the intensity of light reflected back from the scene. The tangible medium may refer to, for example, an array of pixels.

As used herein, a “module” includes logic, a program, a subroutine, a portion of a program, a software component or a hardware component capable of performing a stated task, function, operation, or process. A module can exist as hardware, software, firmware, or combinations thereof. Furthermore, one module may be distributed over several components or physical devices, so long as there are resources that cooperate with one another to perform the stated functions of the module.

The term “depth” means a depth-wise distance. The depth refers to a distance between a sensor (or other reference point) and an object that is being viewed by the sensor. The depth can also be a relative term such as the vertical distance from a fixed point or plane in the scene closest to the camera.

A “computer-readable medium” includes any medium wherein stored or carried instructions can be retrieved or otherwise read by a processor that can execute the instructions.

The terms “recognize” or “recognition” mean to determine one or more identification features of an object. The identification features may correspond to any feature that enables the object to be identified from one or more other objects, or classes of objects. In one embodiment, the identification features are for classifying an object into one or more pre-defined classes or categories. In another embodiment, identification features may also refer to determining one or more features that uniquely identify the object from all other known objects. Such an identification may alternatively be expressed as classifying the object in a class where there is only one member.

The term “scene” means an area of view for a sensor or image capturing device.

C. System Description

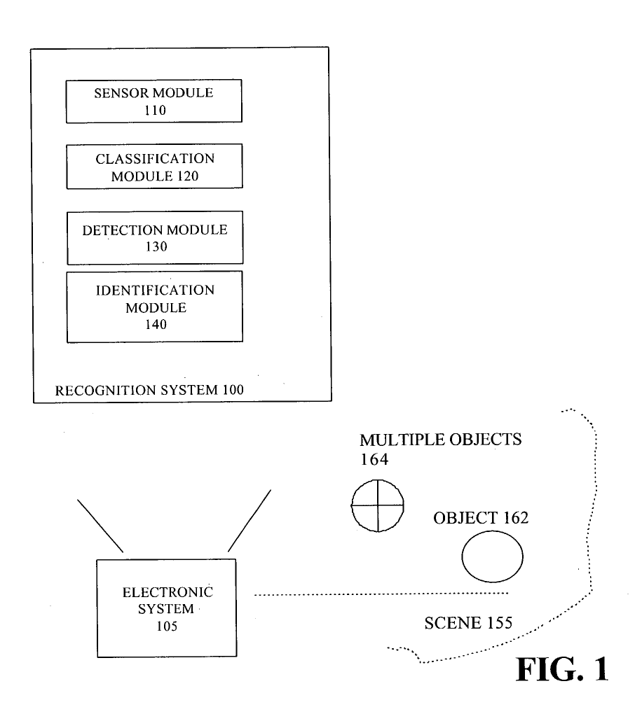

FIG. 1 illustrates a system for recognizing objects, under an embodiment. The system includes an object recognition system 100 and an electronic system 105. The object recognition system 100 provides control or input data for operating the electronic system 105. In one embodiment, object recognition system 100 includes sensor module 110, a classification module 120, a detection module 130, and an identification module 140. However, in another embodiment, the object recognition system may only include one or two of the classification module 120, the detection module 130 and the identification module 140. Thus, embodiments of the invention specifically contemplate, for example, the object recognition system as containing only the classification module 120, or only the detection module 130, but not necessarily all three of the recognition modules.

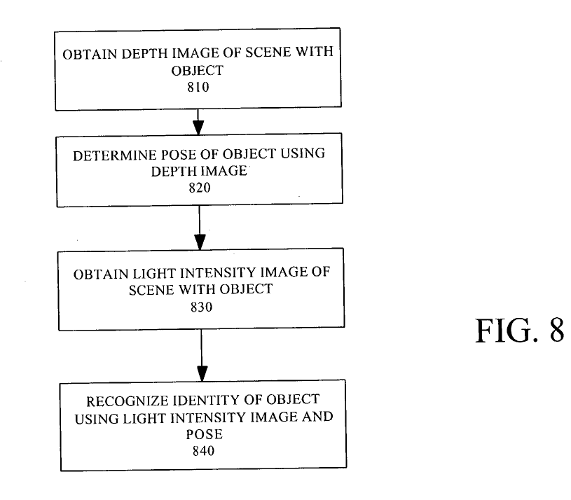

The sensor module 110 views the scene 155. In one embodiment, sensor system 110 includes a depth perceptive sensor. A depth perceptive sensor may employ various three-dimensional sensing techniques. For example, the sensor system may utilize the pulse or modulation of light and use the time of flight to determine the range of discrete portions of an object. Other embodiment may use one or more techniques, including active triangulation, stereovision, depth from de-focus, structured illumination, and depth from motion. U.S. Pat. No. 6,323,942, entitled “CMOS Compatible 3-D Image Sensor” and U.S. Pat. No. 6,515,740, entitled “Methods for CMOS-compatible three-dimensional image sensing using quantum efficiency modulation” (hereby incorporated for all purposes in its entirety) describes components and techniques that can be employed to obtain the sensor information. In another embodiment, the sensor module 110 includes light-intensity sensors that detect the intensity of light reflected back from the various surfaces of the scene 155. Still further, an embodiment may provide that sensor module 110 includes both depth perceptive sensors and light intensity sensors. For example, as described with FIG. 8, a depth perceptive sensor may be used to enhance or supplement the use of a light intensity sensor.

The classification module 120 uses information provided by the sensor module 110 to classify an object 162 that is in the scene. The information provided by the sensor module 110 may identify a classification feature, for example, that enables a class or category of the object(s) 162 to be determined. The classification of the object may then be provided to the electronic system 105 for future use. The particular classes or categories in which the object(s) 162 may be identified with may be predefined.

The detection module 130 may identify the object 162 from other objects in the scene 155. The detection module may also identify a particular portion of the object 162 from the remainder of the object. In one embodiment, since the particular portion may exist on only one category of the object, the particular portion is not detected unless the object is first classified as being of a particular category. In another embodiment, the identification features obtained for the object portion is distinctive enough that the object portion of interest can be detected without first classifying the entire object.

The identification module 140 performs a more complex recognition in that it can determine the identity of the particular object. Multiple identification features may be detected and recognized in order to make the identification of the particular object. In one embodiment, the identification module 140 uniquely identifies an object belonging to a particular class or category. For example, as will be described, the identification module 140 may be for facial recognition, in which case the identity of the face is determined. This may correspond to gaining sufficient information from the face in order to uniquely identify the face from other faces. This may also correspond to being able to associate an identification of a person with the recognized face.

There may be multiple objects 164 in one scene at the same time. Alternatively, object 162 may be separately recognizeable portions of the same object. In either case, recognition system 100 may separately operate on each of the multiple objects 164, or object portions separately. For example, each of the objects 164 may be separately classified by classification module 120, where different objects have different classifications. Alternatively, one of the objects 164 may be classified, another object may be detected by detection module 130, and still another of the objects may be identified by identification module 140.

The particular type of types of recognition performed, the objects 162, 164 that are recognized, and the particular scene 155 in which objects are recognized may vary depending on the application for which an embodiment is applied. For example, object 162 may correspond to a person, or a person's face. As another example, the scene 155 may correspond to a door entry, a security terminal, and the interior of a vehicle. The objects 164 may include different occupants or occupying objects of a vehicle, such as adults, children, pets, and child seats.

The electronic system 105 may provide for an environment or application for the recognition system 100. For example, electronic system 105 may correspond to an automobile controller that uses the classification determined by classification module 110 to configure deployment of the airbags. The automobile controller may use the information provided by the detection module 130 to determine the location of a person's head or face prior to deployment of an airbag. The automobile controller may use the information provided from the identification module 140 as a security mechanism. For example, the automobile controller may be used to determine that the person who is entering the automobile is one of the authorized users of the automobile.

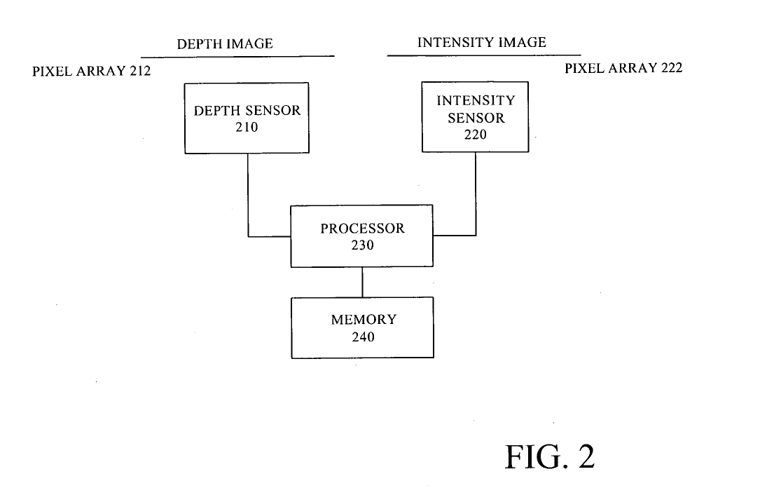

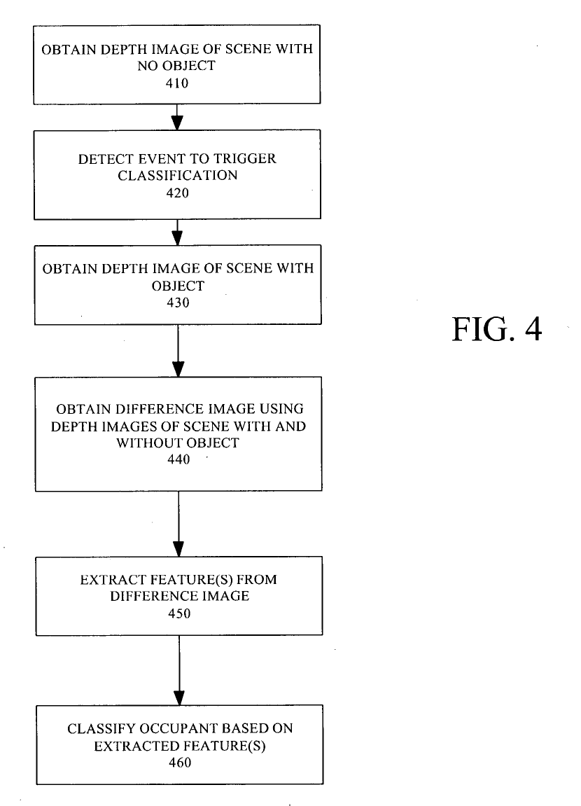

FIG. 2 illustrates components for use with a recognition system, under an embodiment of the invention. A system such as described in FIG. 2 may be used to implement, for example, the recognition system 100 of FIG. 1. In an embodiment, a recognition system 200 includes at least one of a depth sensor 210 or a light intensity sensor 220. The depth sensor 210 is any sensor that is depth-perceptive. The recognition system 200 may also include a processor 230 and a memory 240. The processor 230 and the memory 240 may be used to execute algorithms such as described in FIG. 4 and FIGS. 7-10. The processor 230 and memory 240 may use output from the depth sensor 210 and/or light-intensity sensor 220 to execute the algorithms. The system commands and outcome of recognition may be exchanged with outside using input/output unit 250.

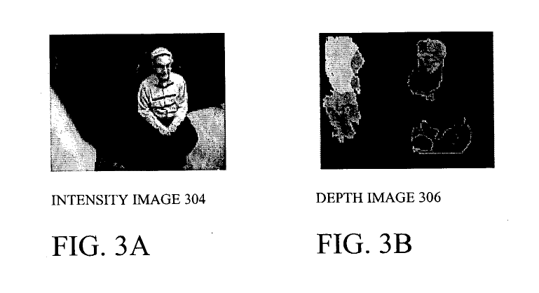

In an embodiment, the output of one or both of the depth sensor 210 or the light-intensity sensor 220 is an image. FIG. 3A illustrates the output of the light-intensity sensor 220. The output corresponds to an intensity image 304 that captures light reflected off of the various surfaces of scene 155 (FIG. 1). This output may be captured on an array of pixels 222, where each of the pixels in the array detect the intensity of light reflecting off of a particular surface region of the scene 155. FIG. 3B illustrates an output image 306 of the depth sensor 210. This output may be captured on an array of pixels 212, where each of the pixels in the array detect depth of a small surface region of the scene 155 (FIG. 1) when measured from the depth sensor 210 (or some other reference point). Each pixel of an intensity image gives the brightness value of particular part of the scene, whereas each pixel of a depth image gives the distance of that particular location to the depth sensor 210.

In an embodiment, depth sensor 210 is preferred over the light-intensity sensor 220 because the depth sensor's output image 306 is invariant to factors that affect lighting condition. For example, in contrast to the output of the light-intensity sensor 220, the output of depth sensor 210 would not saturate if the scene was to change from dim lighting to bright lighting.

D. Object Classification

An occupant classification system detects the presence of an object in a scene, and then classifies that object as belonging to a particular class or category. In one embodiment, these categories might include an adult human being, a child human being, an infant human being, a pet, or a non-animate object. Basic identification features may be detected and used in order to make the classifications.

One application where occupant classification system is gaining use is with vehicle restraint and airbag deployment systems. In such systems, airbag deployment may be conditional or modified based on the occupant of a seat where the airbag is to be deployed. For example, an object may be detected in a front passenger seat. The occupant classification system could classify the object as an adult, a child, a pet or some other object. The airbag system could then be configured to be triggerable in the front passenger seat if the object is classified as an adult. However, if the object is classified as something else, the airbag system would be configured to not deploy in the front seat. Alternatively, the airbag system could be configured to deploy with less force in the front seat if the occupant is a child.

In the example provided above, three possible classifications (adult, child, other) are possible for an object detected in a scene, where the scene corresponds to a space above the front passenger seat. According to one embodiment, an object classification is made using depth perceptive sensors that detect the range of a surface of the object from a given reference. In another embodiment, a light-intensity sensor may be used instead of, or in combination with the depth perceptive sensors.

A method of FIG. 4 describes one embodiment where object classification is made using depth information, such as provided by depth sensor 210. Reference to elements of other figures is made for illustrative purposes only, in order to described components that are suitable for use with a particular step of the method.

In one embodiment, step 410 provides for a preprocessing step where a depth image of the scene 155 is obtained without any object being present in the scene. This provides a comparison image by which object classification can performed in subsequent steps. As an example, in the instance where an object classification system is used for airbag deployment, a background image is taken when the front passenger seat is empty. This image could be obtained during, for example a manufacturing process, or a few moments before the occupant sits on the seat.

In step 420, an event is detected that triggers an attempt to classify an object that enters the scene 155. The event may correspond to the object entering the scene 155. Alternatively, the event may correspond to some action that has to be performed, by for example, the electronic system 155. For example, a determination has to be made as to whether an airbag should be deployed. In order to make the determination, the object in the seat has to be classified. In this case, the event corresponds to the car being started, or the seat being occupied. A depth image that is different from the empty seat can be used as the triggering event as well. Once the triggering event occurs, the object classification module 120, for example, will classify an object in the front passenger seat for purpose of configuring the airbag deployment.

Step 430 provides that a depth image is obtained with the object in the scene 155. In one embodiment, depth sensor 210 (FIG. 2) captures a snap-shot image of the scene 155 immediately after the triggering event in step 420.

In a another embodiment, steps 420 and 430 may be combined as one step. For example, in one application, the depth image of a scene may be taken, and the object is detected from the depth image. Thus, the depth image having the object may be the event. For example, the depth image of a scene may be taken periodically, until an object is detected as being present in the scene.

Step 440 provides that a difference image is obtained by comparing the image captured in step 430 with the image captured in step 410. The difference image results in an image where the occupant is segmented from the rest of the scene 155. The segmented image may correspond to the image of step 430 being subtracted from the image of step 410. If there are multiple objects in the scene, each object corresponds to a different segment. Each segment is then processed separately for individual classification.

For example, in the application for airbag deployment, when there is an occupant on the seat, the occupant can be segmented by subtracting the background image from the image with the occupant. Due to the signal noise in a depth sensor, the difference image may contain some holes or spurious noise. Alternatively, when light-intensity images are used, the intensity level of an occupant could be same as the seat in various locations, thereby creating a similar effect to the holes and spurious noise of the depth image. The unwanted portions of the depth image (or alternatively the intensity image) could be eliminated using morphological processing. More specifically, a morphological closing operation may be executed to fill holes, and a morphological opening operation may be executed to remove the noise.

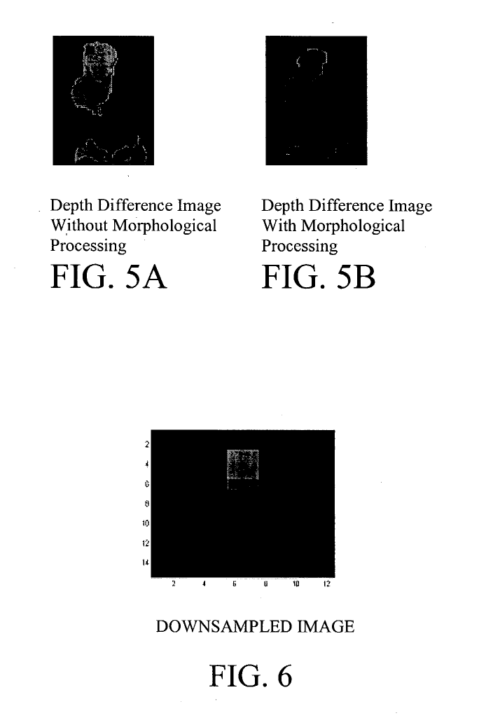

FIG. 5A-5B illustrate a difference image before morphological processing is applied. FIG. 5B illustrates a difference image after morphological processing is applied. For illustrative purposes, the image where morphological processing is applied is a depth image, although the same processes may be used with the light-intensity image.

As an alternative to using background subtraction and morphological processing to obtain a good difference image, step 440 may be performed by eliminating the background using a range expectation of the foreground. More specifically, a fixed threshold based method, or an adaptive threshold based method could be applied to obtain the foreground objects in the image. Such an embodiment would be better suited for when the depth sensor 210 (FIG. 2) is employed to obtain a depth image.

Step 450 provides that features are extracted from the difference image. Two illustrative techniques are described for extracting features from an image such as a difference image. The first technique described, termed a principle component algorithm (PCA) (or sometimes referred as singular value decomposition and described in Matrix Computations, by G. H. Golub and C. F. Van Loan, Second Edition, The Johns Hopkins University Press, Baltimore, 1989.), is based on representation of the shapes by a linear combination of orthogonal shapes that are determined by a principal component analysis. The second method described provides heuristic based features.

The PCA technique provides that images are preprocessed such that a downsampled version of the image around the seat is saved. The downsampling can be done by any means, but preferably using averaging, so that the downsampled version does not contain noisy data. A downsampled image is illustrated in FIG. 6. The columns of this image can be stacked on top of each other to construct a vector X. The vector X may be represented in terms of a neutral shape X₀ and orthogonal basis shapes Uₖ's as follows:

$$X = {X}_{0} + {\sum }_{k = 1}^{n} {α}_{k} {U}_{k} \qquad ( Equation 1 )$$

where αₖ are interpolation coefficients. The orthogonal basis shapes are calculated by applying a PCA technique on a collection of training set that involves all types of occupants. From this training set of images, a matrix A is constructed such that each image vector constructs a column of A. The average of columns of A give the neutral shape X₀. Next X₀ is subtracted from every column of A.

Let B be the resulting matrix. Singular value decomposition is applied to matrix B such that:

B=USV^{T} (Equation 2)

where U and V are orthonormal matrices, and S is a diagonal matrix that contains the singular values in the decreasing order. The basis shapes (principal components) Uₖ's are given as the columns of the U matrix of singular value decomposition.

A PCA technique carries the distinction between various classifications and categories implicitly. Therefore, it should be the classifier's task to identify these distinctions and use them properly.

A second technique for performing step 450 may be based on heuristics features. Specifically, heuristics based features are chosen such that the distinction between various groups are explicit. These features may be obtained from the segmented images. Examples of heuristics based features include the height of the occupant, the perimeter of the occupant, the existence of a shoulder like appearance, the area of the occupant, the average depth of the occupant, the center locations of the occupant, as well as identifiable second moments and moment invariants.

In step 460, the occupant is classified based on the extracted feature(s) of step 450. Classification algorithms may be employed to perform this step. Typically, a classification algorithms consist of two main stages: (i) a training stage, where a classifier learning algorithm is implemented and (ii) a testing stage where new cases are classified into labels. The input to both of these stages are features from the previous stage.

A classifier learning algorithm takes a training set as input and produces a classifier as its output. A training set is a collection of images that have been individually labeled into one of the classes. The classifier algorithm finds a distinction between the features that belong to training images, and determines the discriminator surfaces in the space. The classifier function is the output of the training stage, and it is a function that gives the label of a feature vector by locating it with respect to the discriminator surfaces in space.

The input to the testing stage is a test image and its corresponding feature vector. The learnt classifier function (from training) is applied to this new case. The output of the algorithm is the corresponding label of the new case.

There are various algorithms in the literature for the classification task. This algorithms include Neural Networks, nearest neighbor classification, Hidden Markov Classifiers, Linear Discriminant Analysis and Support Vector Machine (SVM) classification are some of the many classification algorithms. Any of these algorithms can be applied to the problem of occupant classification by using our feature vectors. One such classification technique that has been selected for additional detail is SVM.

Without loss of generality, a two-class classification problem can be considered in describing the application of an SVM technique. Such a problem may correspond to where it is desired to obtain a classification between a particular class versus all other classes. The SVM classifier aims to find the optimal differentiating hyperplane between the two classes. The optimal hyperplane is the hyperplace that not only correctly classifies the data, but also maximizes the margin of the closest data points to the hyperplane.

Mathematically, a classifier can also be viewed as a hypersurface in feature space, that separates a particular object type from the other object types. An SVM technique implicitly transforms the given feature vectors x into new vectors φ(x) in a space with more dimensions, such that the hypersurface that separates the x, becomes a hyperplane in the space of φ(x)'s. This mapping from x to φ(x) is used implicitly in that only inner products of the form K(xᵢ,xⱼ)=φ(xᵢ)^{T}φ(xⱼ) need ever to be computed, rather than the high dimensional vectors φ(x) themselves. In these so-called kernels, the subscripts i,j refer to vectors in the training set. In the classification process, only the vectors that are very close to the separating hypersurface need to be considered when computing kernels. These vectors are called the support vectors (SV). Suppose that vector xᵢ in the training set is given (by a person) a label yᵢ=1 if it is a particular type of class, i.e adult and yᵢ=−1 if it is not. Then the optimal classifier has the form:

$$f ( x ) = sign ( {\sum }_{{SV}^{′} s}^{} {α}_{i} {y}_{i} K ( {x}_{i} , x ) + b ) \qquad Equation ( 2 )$$

Where SV denotes the set of support vectors, and the constants αᵢ and i are computed by the classifier-learning algorithm. Computing the coefficients αᵢ,b is a relatively expensive (but well understood) procedure, but needs to be performed only once, on the training set. During volume classification, only the very simple expression (A) needs to be computed.

In order to apply SVM techniques to occupant classification problems, a generalization of the classification problem is made that there exists more than two classes. Let Cᵢ be the class belonging to the i^{th} occupant type. Using SVM, the best differentiating hypersurface can be deduced for each class. This hypersurface is the one that optimally differentiates the data belonging to the particular class Cᵢ, from the rest of the data belonging to any other Cⱼ.

Having obtained the hypersurface for each class, a test vector is classified. First, the location of the new data is determined with respect to each hypersurface. For this, the learnt SVM for the particular hyperplane is used to find the distance of the new data to that hypersurface using the distance measure in equation A.

While testing each new case, the particular probabilities for each class can be assigned. Let zᵢ be the distance of the new data point to the ith class distinguishing hypersurface. The probability that the new data belongs to the ith class is assigned by,

$$P ( i ) = \frac{{ⅇ}^{{z}_{i}}}{{\sum }_{ k}^{} {ⅇ}^{{z}_{i}}} \qquad Equation ( 3 )$$

Once the probability function is obtained for each class, the most probable occupant type is given as the final decision of the system.

SVMs minimize the risk of misclassifying previously unseen data. In addition, SVMs pack all the relevant information in the training set into a small number of support vectors and use only these vectors to classify new data. This makes support vectors very appropriate for the occupant classification problem. More generally, using a learning method, rather than hand-crafting classification heuristics, exploits all of the information in the training set optimally, and eliminates the guess work from the task of defining appropriate discrimination criteria.

A method such as described with FIG. 4 may be modified work with intensity images, as well as depth images.

E. Object Detection System

An object detection system detects the presence of a specific type of object from other objects. In an embodiment, an object of interest is actually a portion of a larger object. When the larger object enters a scene, an embodiment provides that the portion of the object that is of interest is detected. Furthermore, such an embodiment may detect additional information about the object of interest, including its orientation, position, or other characteristics.

In one embodiment, the object of interest is a face. When a person enters a scene, an embodiment provides that the person's face is detected. Included in the detection may be information such as the orientation of the face and the shape of the face. Additional heuristic information may also be obtained about the face, or about the person in conjunction with the face. For example, the height of the person and the position of the face relative to the person's height may be determined contemporaneously with detection of the person's face.

According to an embodiment, the fact that a face is detected does not mean that the face is identified. For example, an identity of the person is not determined as a result of being able to detect the presence of the face. Rather, an embodiment provides that the identification is limited to knowing that a face has entered into the scene.

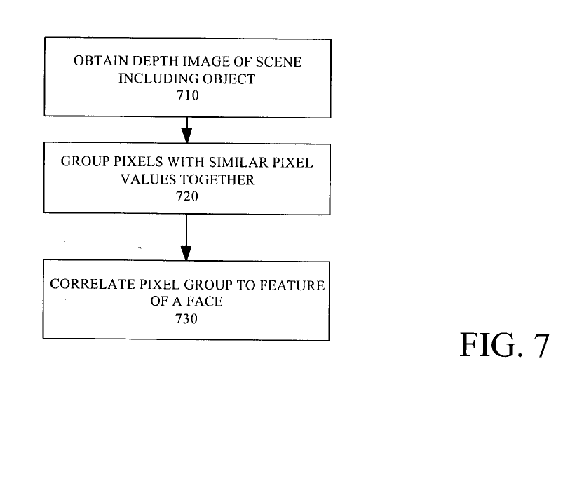

FIG. 7 illustrates an embodiment for detecting a person's face. A method such as described by FIG. 7 may be extrapolated to detect any object, or any portion of an object, that is of interest. A face is described in greater detail to facilitate description of embodiments provided herein. A method such as described in FIG. 7 may be implemented by the detection module 130 (FIG. 1). Reference to numerals described with other figures is intended only to provide examples of components or elements that are suitable for implementing a step or function for performing a step described below.

Step 710 provides that a depth image of the scene is obtained. The depth image may be obtained using, for example, depth sensor 210. Alternatively, the depth image may be known information that is fed to a component (such as detection module 130) that is configured to perform a method of FIG. 7. The image may be captured on pixel array 212, where each of the pixels carry depth information for a particular surface region of the scene 155 (FIG. 1).

In step 720, adjacent pixels that have similar depth values in pixel array 212 (FIG. 2) are grouped together. In performing this step, one embodiment provides that if there is a prior expectation for the depth of a face, then the objects that have values that are inconsistent with that expectation can be directly eliminated. Next, in order to group pixels with similar depths, standard segmentation algorithms can be applied on the remainder of the depth image. For instance, the classical image split-and-merge segmentation method by Horowitz and Pavlidis splits an image into parts. It then tests both individual and adjacent parts for “homogeneity” according to some user-supplied criterion. If a single part does not satisfy the homogeneity criterion, a split portion of the image is split again into two or more parts. If two adjacent parts satisfy the criterion even after they are tentatively regarded as a single region, then the two parts are merged. The algorithm continues this procedure until no region need be split, and no two adjacent regions can be merged. Although this particular algorithm was used in the past for regular brightness or color images, embodiments of the invention provide for applying such an algorithm to depth images as well.

In another embodiment, step 720 may be performed using a segmentation algorithm that is applied on the gradient of the depth image, so that the value of any threshold used in the homogeneity criterion becomes less critical. Specifically, a region can be declared to be homogeneous when the greatest gradient magnitude in its interior is below a predefined threshold.

Another alternative is to use a k-means algorithm to cluster pixels of the depth image into regions with similar depths. A shortcoming of such an algorithm is that it is usually hard to determine a priori a good value for the number k of clusters to be computed. To overcome this problem, an adaptive scheme for the selection of k can be applied as described in “Shape Recognition With Application To Medical Imaging,” Chapter 4, Ph.D. Thesis, April 2002, Stanford University, author Salih Burak Gokturk (incorporated by reference herein in its entirety). Standard image segmentation methods such as the normalized cut method described in “Normalized Cuts and Image Segmentation,” Int. Conf. Computer Vision and Pattern Recognition, San Juan, Puerto Rico, June 1997, authors J. Shi and J. Malik, can also be applied to find the segments that belong to objects at different depths.

Once different segments are found with one of the methods above, step 730 provides that the segment of pixels correlating to a face are identified. Each segment of pixels may be tested to determine whether it is a portion of a face. Assuming a face is present, portions of the face may be found from the pixels through one of the method as follows. A standard edge detector, such as the Sobel or Canny edge detector algorithm as described in Digital Image Processing, Addison Wesley, 1993, by R. C. Gonzales, R. E. Woods, may be used to find the contour of each facial segment. Subsequently, the face contours can be fitted with a quadratic curve. By modeling contours as a quadratic curve, rather than an ellipse, situations can be covered where part of the face is out of the image plane. The equation of a quadratic is given as follows:

αx²+by²+cxy+dx+ey+f=1 Equation(4)

where x and y denote the coordinates of contour points and a, b, c, d, e, and f denote the quadratic curve parameters. In order to find the curve parameters the equations are rewritten as follows:

$$[ \begin{matrix}{x}^{2} & {y}^{2} & xy & x & y & 1\end{matrix} ] [ \begin{matrix}a \\ b \\ c \\ d \\ e \\ f\end{matrix} ] = [ 1 ] \qquad Equation ( 5 )$$

A system of equations of this form can be written with one equation for each of several points the contour, and the linear least-squares solution gives the parameters of the quadratic that best fits the segment contour. Segments that do not fit the quadratic model well can be eliminated. More specifically, the contours that have a residual to the quadratic that fit greater than a threshold are discarded.

In some cases, the face and the body of a person can be at the same or similar depth from the camera. In these cases, the segmentation algorithm is likely to group body and face as one segment. In order to separate the face and the neck from the rest of the body, one can use heuristic features to distinguish pixels that observe the face from, for example, pixels that observe the shoulder. For example, a heuristic observation that the face and the neck are narrower than the shoulder in an image may be used to figure out which segment of pixels corresponds to the face. To employ this observation, the system first finds the orientation of the person with respect to the camera by analyzing the first order moments of the boundary. This may be done by approximating the boundary with an ellipse. The major axis of the ellipse extends along the body and the head, and the shoulders can be detected from the sudden increase in the width of the boundary along the major axis.

A final, optional stage of the detection operation involves face-specific measures on the remaining segments. For instance, the nose and the eyes result into hills and valleys in the depth images, and their presence can be used to confirm that a particular image segment is indeed a face. In addition, the orientation of the head can be detected using the positions of the eyes and the nose. Other pattern matching methods could also be pursued to eliminate the remaining non-face segments.

Various other methods exist for the detection of the faces from depth maps. A quadratic face model is appropriate for most of the cases, but such models do not hold well when there are partial occlusions. A more descriptive face model, such as a detailed face mask, may be necessary in such cases. The problem is then reduced to finding the rotation and translation parameters for the pose of the face, and deformation parameters for the shape of the face. The method described in an article entitled “A data driven model for monocular face tracking”, in International conference on computer vision, in International Conference on Computer Vision, ICCV 2001, authored by Gokturk S B., Bouguet J Y, Grzeszczuk R (the aforementioned article being incorporated by reference herein) can be used for this purpose.

Another alternative is to use depth and intensity images together for the face detection task. Many past approaches have used the intensity images alone for this task. These techniques, first, extract features from candidate images, and next apply classification algorithms to detect if a candidate image contains a face or not. Techniques such as SVMs, neural networks and HMMs have been used as the classification algorithms. These methods could be combined by the depth images for more accurate face detection. More specifically, the depth images can be used to detect the initial candidates. The nearby pixels can be declared as the candidates, and standard intensity based processing can be applied on the candidates for the final decision.

Statistical boosting is an approach for combining various methods. In such an approach, different algorithms are sequentially executed, and some portion of the candidates are eliminated in each stage. This method is applicable to object recognition, and object detection in particular. In each stage, one of the algorithms explained above could be used. The method starts from a less constraining primitive face model such as a circle, and proceeds to more constraining primitive shapes such as quadratic face model, perfect face mask, and intensity constrained face mask.

Another alternative is the histogram-based method for the detection of face and shoulder patterns in the image. In this method, the histogram of foreground pixel values is obtained for each row and for each column. The patterns of the row and column pixel distributions contain information on the location of the head, and shoulders and also on the size of these features (i.e., small or big head, small or big shoulder, etc.).

Examples of applications for embodiments such as described in FIG. 7 are numerous. For face detection, for example, such applications include security monitoring applications in shops, banks, military installations, and other facilities; safety monitoring applications, such as in automobiles, which require knowledge of the location of passengers or drivers; object-based compression, with emphasis on the face in video-phone and video conferencing applications.

F. Determining Object Identity

According to an embodiment, a recognition system may perform a complex recognition that identifies features that can be used to uniquely identify an object. For example, identification module 140 of the recognition system 100 may be used to identify unique features of a person's face. As an optional step, an attempt may be made to determine the identity of the person based on the identified facial features.

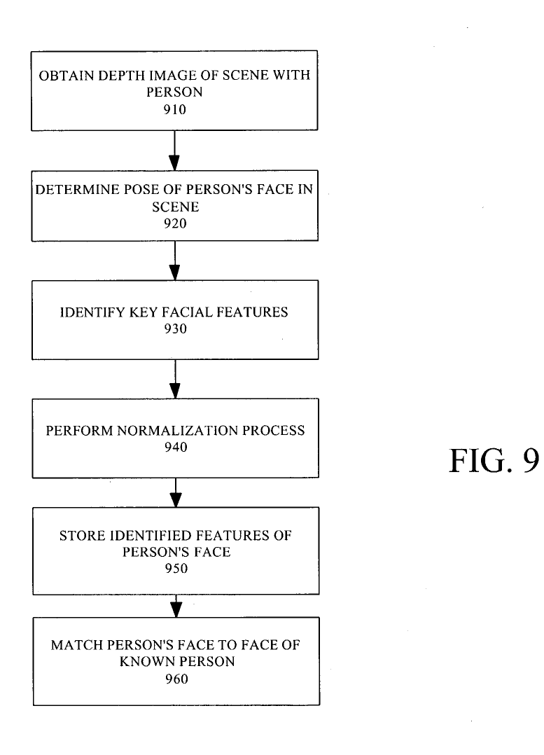

Embodiments of the invention utilize a depth perceptive sensor to perform the recognition needed to determine the identity of the object. In an embodiment such as described in FIG. 8, depth information about the position of the object of interest is used indirectly to supplement a conventional identity algorithm that use light-intensity images for recognition. In an embodiment such as described in FIG. 9, a depth image is directly used to determine the identity of the object. In describing methods of FIG. 8 and FIG. 9, reference may be made to elements of other figures. Such references are made for illustrative purposes only, in order to described components that are suitable for use with a particular step of the respective methods.

In FIG. 8, step 810 provides that a depth image of a scene with an object in it is obtained. The depth image may be obtained using, for example, depth sensor 210. The depth image may be captured similar to a manner such as described in step 710, for example.

In step 820, the pose of the object is determined using information determined from the depth image. The pose of an object refers to the position of the object, as well as the orientation of the object.

In step 830, a light intensity image of the scene is obtained. For example, such an image may be captured using a light-intensity sensor 220 such as described in FIG. 2.

In step 840, the identity of the object is recognized using both the light-intensity image and the depth image. In one embodiment, a traditional recognition algorithm is executed using the light-intensity image. The traditional algorithm is enhanced in that the depth image allows such algorithms to account for the pose of the object being recognized. For example, in many existing facial recognition algorithms, the person must be staring into a camera in order for the algorithm to work properly. This is because it is not readily possible to identify the pose of the person from the light-intensity image. Thus, slight orientations in the manner a person faces the camera may cause traditional recognition algorithms to deviate. However, according to an embodiment such as described in FIG. 8, such recognition algorithms may be made invariant to such movements or positions of the user's face. In particular, embodiments such as described herein provide that the depth image can be used to account for the orientation of the face.

FIG. 9 illustrates a method where a depth image is directly used to recognize a face, under an embodiment of the invention. Step 910 provides that a depth image of the person in the scene is obtained. This step may be accomplished similar to step 810, described above.

Step 920 provides that a pose of a person's face is determined. Understanding the pose of a person's face can be beneficial for face recognition because the face may be recognized despite askew orientations between the face and the sensor. Furthermore, determining the pose using a depth image enables the facial recognition to be invariant to rotations and translations of the face.

Various methods can be applied to understand the pose of a person or his face. Let R be the rotation and T (tₓ, t_{y}, t_{z}) be the translation of the face. R can be modeled by three rotation angles (α,β,γ) around three translational axes x,y, and z. Let X₀ be the normalized location of the points on the face. The transformation matrix can be written as follows:

$$T = [ \begin{matrix}{c}_{α} {c}_{β} & {c}_{α} {s}_{β} {s}_{γ} - {s}_{α} {c}_{γ} & {c}_{α} {s}_{β} {c}_{γ} + {s}_{α} {s}_{γ} & {t}_{x} \\ {s}_{α} {c}_{β} & {s}_{α} {s}_{β} {s}_{γ} + {c}_{α} {c}_{γ} & {s}_{α} {s}_{β} {c}_{γ} - {c}_{α} {s}_{γ} & {t}_{γ} \\ - {s}_{β} & {c}_{β} {s}_{γ} & {c}_{β} {s}_{γ} & {t}_{z} \\ 0 & 0 & 0 & 1\end{matrix} ] \qquad Equation ( 6 )$$

where c and s denote cosine and sine respectively. Then the rotated and translated point (X_{M}) can be written as:

X_{M}=TX₀ [symbol] X₀=T⁻¹X_{M} Equation (7)

where X_{M} and X₀ are 4-dimensional vectors that are in the form of [x y z 1]^{T} where x,y,z give their location in 3-D.

Then the requirement for normalization (step 940) will be to find the rotation and translation parameters (R and T). This task is easily handled using three-dimensional position information determined from depth sensor 210 (FIG. 2).

Step 930 provides that facial features are identified. This may be performed by identifying coordinates of key features on the face. The key features may correspond to features that are normally distinguishing on the average person. In one embodiment, the eyes and the nose may be designated as the key features on the face. To determine the location of these features, a procedure may be applied wherein the curvature map of the face is obtained. The tip of the nose and the eyes are demonstrated by the hill and valleys in the curvature map. The nose may be selected as the highest positive curvature and the eyes are chosen as the highest two negative curvature-valued pixels in the image. Finally, the three-dimensional coordinates of these pixels are read from the depth sensor 210.

One of the features on the face can be designated as the origin location, i.e., (0,0,0) location. In one embodiment, the tip of the nose may correspond to the origin. Then, the translation of the three-dimensional mesh (T) is given as the three-dimensional coordinate of the tip of the nose in the image. All of the points on the mesh are translated by this amount. One of the axes in the original image may be assumed to be the z-axis. In one embodiment, the z-axis may be assumed to correspond to the line that connects the tip of the nose with the middle location between the eyes. Let Z be the distance of the tip of the nose and this location. Therefore, the location of this point on the normalized model should be (0,0,Z) since this point is on the Z-axis. This equation provides a three-equation system for the three unknowns of the rotation matrix. Therefore, using this information, and writing the transformation equations (with T=(0,0,0)), one can solve for the rotation parameters.

In step 940, a normalization process is performed to account for a pose of the person or his face. The normalization on the pose is straightforward given the pose transformation matrix, as found in the previous section. Then the following equation is used to find the normalized shape:

X₀=T⁻¹X_{M} Equation (8)

It should also be noted that a normalization process may be performed to account for illumination conditions in the environment when light-intensity images are being used, either instead of or in combination with depth images. For example, such a normalization process may be used with a method such as described in FIG. 8. The knowledge of the three-dimensional locations of the light sources, and the normal direction of every pixel in the mesh, one could normalize the intensity values at every pose of the face. More specifically, the normal direction of every triangle in the face mesh is found as described in the Computer Graphics: Principles and Practice, by Foley, van Dam, Feiner, and Hughes, second edition in C, Addison-Wesley. Then, the intensity value of the triangle is corrected by using its normal direction. In one embodiment, in the case of uniform lighting, the intensity value of each triangle is corrected by dividing by the cosine of the angle between the normal direction and the camera viewing angle.

Step 950 provides for storing features of a face for a subsequent matching step. The identified features of the face image may be stored in a particular form or representation. This representation may be easier to subsequently process. Furthermore, such a representation may eliminate many of the variations that may result from factors other than facial features. For example, the representation of the identified face may be such that it has the same direction and contains similar lighting as other images to which it will be compared against.

There are various methods to represent a three-dimensional face for subsequent matching. One alternative is to represent the surface of the face and match the surface. For instance, a volumetric representation can be constructed and every voxel in the surface of the face is set to one, while all the other pixels are set to zero. Similarly, the surface can be represented by a three dimensional mesh, and the locations of the pixels of the mesh are kept for the representation.

In another embodiment, the face is stored by a volumetric representation. In this case, all the voxels that are in the face and head are stored as one, whereas the other voxels (the voxels in the air) are kept as zero.

Still further, another embodiment provides that the facial surface is represented by a depth image. In this case, the inputs are processed with image processing algorithms. In such an embodiment, both a depth image and a light-intensity image may be obtained. While doing so, the intensity image can be kept and be used for matching as well.

Step 960 provides for matching the representation of the recognized face to a representation of a stored face that has a known identity. According to one embodiment, there are two stages to this step. First, a database of face representations are constructed in a training stage. For this purpose, the images of many people (or people of interest, e.g. family living in a house) are captured and normalized in a manner such as described in steps 920-940. The identities of the individuals with the faces are known. The representations, along with the corresponding identities, are then put in a database. Next is a testing stage, where the representation of a person is matched against the representations in the database.

Once the face shape is represented, step 960 further provides that the three-dimensional face representation is matched with the representations in the database. There are various methods for this purpose. In one embodiment, template matching techniques can be applied. In this case, each representation in a database is matched voxel by voxel to the representation of the test case. For instance, if the representation is in volumetric form, then the value of each voxel is compared using any matching function. For example, the following matching function can be used:

$$M = {λ}_{1} ( {\sum }_{ x , y , z}^{} {I}^{M} ( x , y , z ) - {I}^{T} ( x , y , z ) ) + {λ}_{2} ( {\sum }_{ x , y , z}^{} {C}^{M} ( x , y , z ) - {C}^{T} ( x , y , z ) ) \qquad Equation ( 9 )$$

where M is the matching score, x, y, z are the coordinates in 3-D, λ₁ and λ₂ are constants, and I^{M} and I^{T} are the meshes of a model (from database) and the test case respectively, and C^{M} and C^{T} are the color (intensity) values of those voxels. The score is calculated over various models in the database, and the model with the smallest matching function is chosen as the recognized model.

In another embodiment, the template matching can be applied only around the features in the face. For instance, the voxels around the eyes, eyebrows, the tip of the nose, the lips, etc. are used for the template matching, as opposed to the whole face mesh as described elsewhere in the application.

In another embodiment, a classification framework could be used. For this, first features that represent the face are extracted. Next, a classification algorithm is applied on the features. Embodiments that contain various feature extraction methods and classification algorithms are described next.

In an embodiment, heuristics (anthropometry) based features can be used for classification. Anthropometry is the study of human body measurement for use in anthropological classification and comparison. Any measurements on the face can be used for recognition purpose. For example, the width and height of the face, the distance between the eyes, the measurements of the eye, nose, mouth or other features, the distance between the eyes and the nose, or the nose and the mouth may be used individually, or in combinations, for recognition purposes. These features can then be listed into a vector (feature vector) for representation of the face mesh. The feature vector can then be classified using classification techniques as described.

There are various other methods to extract a feature of the face in form of a feature vector. A feature vector can be used in a classification algorithm, as described herein. One method of obtaining a feature vector is through the use of a PCA technique. In this method, the principal modes of face shape and color variations are obtained by applying singular value decomposition on a collection of training set of faces as described in Matrix Computations, by G. H. Golub and C. F. Van Loan, Second Edition, The Johns Hopkins University Press, Baltimore, 1989. Then, each face is represented by their projection onto the principal components. The projected values are stored in a vector for classification purposes.

The feature vectors for the face can be obtained using any feature representation method. In another embodiment, a feature vector is obtained from the key components (i.e. eye, nose, lips, eyebrows, etc . . . ) of the face. This could involve the application of a PCA technique on regions around the key components, or it could contain the raw image or mesh around the key components.

Once the feature vectors are obtained, they are used as input to a classification algorithm. A classification algorithm consists of two main stages. A training stage, where a discriminating function between the training samples are obtained. This discriminator function is called a classifier function. This is a function that tells which class a case belongs to (given it feature vector). The second stage is called testing, where the classifier function that was learnt through training) is applied to new cases.

There are many classification algorithms in the literature, and one of these algorithms can be applied for the classification of face feature vectors. Among these algorithms, are nearest neighbor algorithm, linear discriminant analysis, neural networks, hidden markov models, and SVM techniques.

G. Applications

There are various applications of the described algorithms for occupant classification, face detection and face recognition. For example, an occupant classification algorithm such as described with FIG. 4 can be used for classifying people/objects in a car, classifying objects in front of a billboard, classifying objects in front of a recognition system, or classifying objects/people in front of a television.

Similarly, a face detection algorithm such as described in FIG. 7 has numerous applications. Some of these applications include as a preprocessing to a face recognition algorithm; security monitoring applications in shops, banks, military installations, and other facilities; safety monitoring applications, such as in automobiles, which require knowledge of the location of passengers or drivers; and object-based compression, with emphasis on the face in video-phone and video conferencing applications.

Face recognition algorithms such as described in FIGS. 8 and 9 have applications such as security monitoring in airports and other places, in an automobile to recognize the driver, and in a keyless entry system. The face recognition algorithms can be used for both authentication or identification. In authentication, the face is matched across a small number of people (for instance to one person, when the authentication to access a computer is to be given, or to the members of a family, when the authentication to access the house is to be given.). In identification, the face is matched across a large number of people. (For instance, for security monitoring in airports, to search for terrorists.)

According to embodiments, a recognition process may be employed where a classification process is performed on an object, followed by a detection process and an identity process. The particular order in which each of the processes are to be performed may vary depending on the particular application. Each of the processes may be performed by components such as described in FIG. 1 and FIG. 2.

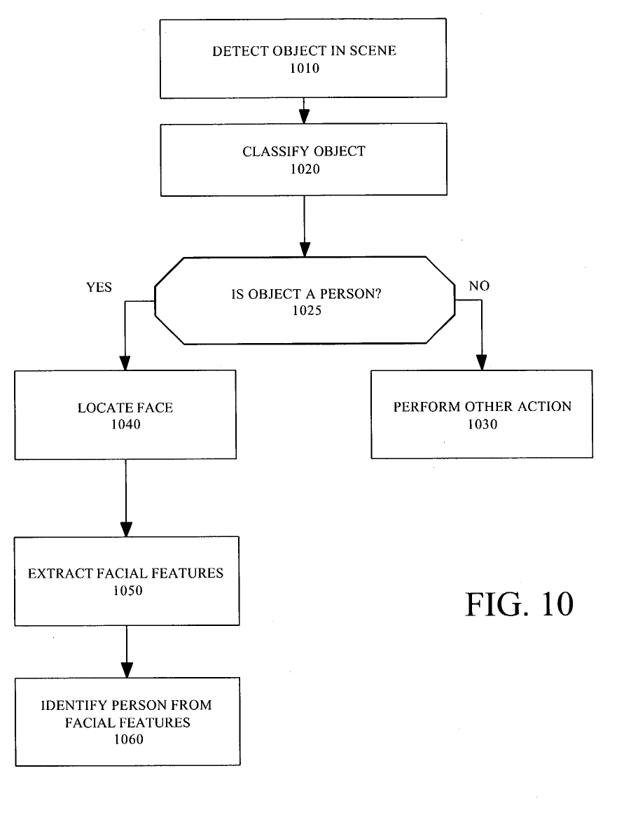

FIG. 10 illustrates one embodiment of an application that requires the passive identification of a person based on the person's face. A similar embodiment can be used to recognize a pet (or both person and a pet) as well. Reference to elements recited with other figures is made to illustrate suitable components for performing a step of the recited method.

In step 1010, an object is detected as entering a monitored scene. The detection of the object may be non-specific, meaning that no distinction is made as to what the object is or its classification. Rather, the detection is made as a trigger to start the passive recognition processes. For example, conventional motion sensors may be used to determine that something new has entered the scene.

Step 1020 provides that the object is classified. In one embodiment for performing facial recognition, the object classification step may be binary. That is, the object is classified as being a person, a pet or other object. This step may involve an object classification algorithm such as described with FIG. 4.

If a determination in step 1025 is that the object is not a person, then step 1030 provides that object specific action can be taken (e.g. if it is a pet, open the pet entrance). The classification determined in step 1020 may be used to determine what the object specific action is. If the determination in step 1025 is that the object is a person, then step 1040 provides that the face of the person is identified from the rest of the person. This step may involve an object detection algorithm such as described with FIG. 7. The detection of the face may account for persons of different height, persons that are translating and/or rotating within the scene, and even persons that are stooping within the scene.

Following step 1040, step 1050 provides that the facial features of the person may be recognized. This step may identify facial features that uniquely identify the person. This step may include a facial recognition process, covered by, for example, a method of FIG. 9.

In step 1060, the person is identified from the recognized facial features. In one embodiment, the recognized facial features are matched to a database where stored facial features are matched to identified persons.

Specific examples of a method such as described in FIG. 10 are provided as follows. One application contemplates that the driver and the passenger of an automobile are monitored using an algorithm such as described in FIG. 10 for various purposes. For example, in one application, the operation of the airbag is adjusted with respect to the occupant type and location in the car seat. In another application, the driver's face and eyes are detected, and consecutively the driver is alerted if he seems to be sleeping or continuously looking in the wrong direction.

In one specific application, a depth image of a car seat is taken. The occupant classification algorithm is applied on the image of the seat, to determine if the occupant is an adult, a child, a child seat, an animal, an object, or an empty seat. The operation of the airbag is adjusted with respect to this information. For example, the airbag operation is cancelled if the occupant is a child or a child seat. If the occupant is an adult or a child, the face of the occupant is detected. This gives the location of the head. If the head is close to the airbag, then the operation of the airbag is adjusted. Since the airbag can damage the head if the head is too close, the operation can be cancelled or de-powered if the head is too close.

Furthermore, the person in the seat may be recognized as being one of the members of a family that owns or routinely drives the car. Accordingly, the seat, seat belt, the height of the steering wheel, the radio station, etc. may be adjusted to the particular family member's preference. If the person is recognized to be somebody out of the family, then a warning signal may be signaled. A picture of the driver may also be sent to the car owner's (or police's) cell phone or computer. Such a system may also be capable of adding new people into the database, by retraining the system and/or by updating the database.

Some of the fields for use with this application include security systems that identify authorized individuals and grant them access to a particular secure area. This includes, for example, identifying employees of a particular firm and granting them access to company property, or identifying members of a household and granting access to the home.

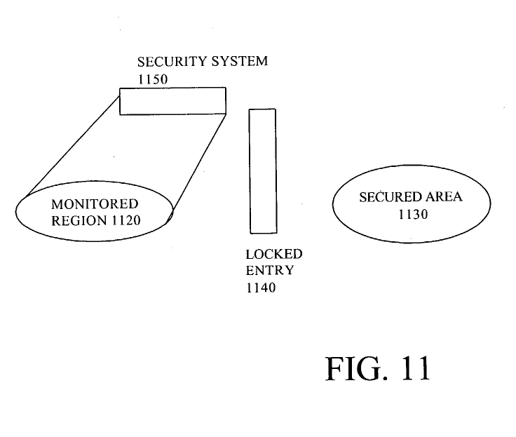

FIG. 11 illustrates a passive, keyless entry system, according to an embodiment. In FIG. 11, a secured area 1130 is protected by a locked entry 1140. A security device 1150 controls the locked entry 1140. The security device 1150 includes sensors that monitor a region 1120. The security device 1150 includes a sensor system that detects when an object is present in front of the locked entry 1140. An algorithm such as described in FIG. 4 may be employed to classify the object as either a person or something else. An algorithm such as described in FIG. 7 may be employed to detect the face of the person. Next, an algorithm such as described in FIGS. 8 or 9 may be used to determine if the person is one of the individuals who lives in the house. A result of recognizing the person may be either that the person is known or unknown. If the person is known, then a determination may be made as to whether the person should be permitted access to the secured area 1130. By determining the identity of the person, security system 1150 also authenticates the person.

In one embodiment, security system 1130 includes a depth sensor which obtains a series of depth images from the monitored region 1120. Once a person that is to be recognized is in the monitored region 1120, an embodiment of the invention provides that the series of frames are “stitched together” and processed, so that characteristics unique to that individual can be identified. These characteristics may be as simple as the nose size or the distance between the eyes, or as complex as three-dimensional data for every single pixel of the subject body, known to a 1 mm resolution. The number of frames that are obtained for the person may range from one to many, depending on the level or recognition being sought, and the length of time needed for the person to take a suitable orientation or pose within the monitored region 1120. The location of the depth sensor used by the security device 1150 may be such that the person who is to be recognized does not have to perform any actions in order to be granted access to the secured area 1130.

More specifically, a system such as described in FIG. 11 may be passive, in that the user is not required to take any action in order to be authenticated and/or authorized. For example, unlike past approaches, the person does not have to place a finger on a fingerprint scanner, look in the direction of a retina scan, or perform other tasks for the security system. The person does not even have to look in a particular direction, as the security system 1150 may be robust to the orientations of the user.

Some other applications or variations to embodiments and applications such as described include the following. A person may be added to a list of authorized individuals by being scanned. The scan may, for example, obtain facial recognition features that will identify the person down the line. The facial recognition features may be stored in a database and associated with the identity of the person. This is accomplished by having authorized individuals approach the system and designating to the system (via a button, computer control, etc.) that they are authorized. In similar fashion, an embodiment may provide for subtracting an “authorized individual” from the database. This is accomplished in opposite fashion from above or via computer interface that enables the system operator to see a list of authorized individuals and remove a specific profile. Still further, an embodiment provides for the ability to track a list of people who enter and exit, regardless of whether they have been granted access or not, to assist ongoing security monitoring activities. Another embodiment provides for the ability to print or view a visible depth map (e.g. wireframe image) so that human system operators may identify individuals within the system.

Embodiments such as described herein may be used to recognize a user for any particular secure application (e.g. “userID” for computer system use) in addition to providing physical security for entering a secure physical area as implied herein.

H. Conclusion

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method for recognizing one or more objects, the method comprising:
obtaining a depth distance between each region in a plurality of regions on a surface of an object in the one or more objects and a reference; and
determining an identification feature of at least a portion of the object using the depth distance between each of the plurality of regions and the reference.

2. The method of claim 1, wherein the step of obtaining a depth distance includes using a sensor system that is configured to measure range information for an object being viewed by the sensor system.

3. The method of claim 1, wherein the step of obtaining a depth distance between each region in a plurality of regions on a surface of the object and a reference includes obtaining a depth image for a scene that includes the object.

4. The method of claim 3, further comprising obtaining a depth image of the scene without the object, and then obtaining a difference image of the object using the depth image of the scene without the object.

5. The method of claim 3, further comprising isolating a depth image of the object from the depth image of the scene using a prior depth expectation of the object.

6. The method of claim 3, further comprising isolating a depth image of the object from the depth image of the scene using a segmentation algorithm.

7. The method of claim 4, wherein determining an identification feature of at least a portion of the object using the depth distance includes using a depth image that isolates the object from the rest of the scene.

8. The method of claim 1, wherein the step of determining an identification feature of at least a portion of the object includes classifying the object as belonging to one or more categories in a plurality of designated categories.

9. The method of claim 8, wherein the step of classifying the object as belonging to one or more categories includes determining that the object is a person.

10. The method of claim 8, wherein the step of classifying the object as belonging to one or more categories includes determining that the object is a child or infant.

11. The method of claim 8, wherein the step of classifying the object as belonging to one or more categories includes determining that the object is a pet.

12. The method of claim 6, wherein the step of classifying the object as belonging to one or more categories includes determining that the object belongs to an undetermined category.

13. The method of claim 6, wherein the step of classifying the object as belonging to one or more categories includes determining whether the object is a child seat.

14. The method of claim 1, wherein obtaining a depth distance includes obtaining the depth distance between each region in a plurality of regions on a surface of multiple objects, and wherein determining an identification feature of at least a portion of the object includes determining the identification feature of at least a portion of each of the multiple objects.

15. The method of claim 1, wherein the step of determining an identification feature of at least a portion of the object includes identifying the portion of the object from a remainder of the object.

16. The method of claim 1, wherein the step of determining an identification feature of at least a portion of the object includes detecting that the object is a person.

17. The method of claim 1, further comprising detecting that a person is in a scene that is being viewed by a sensor for obtaining the depth distances, and wherein the step of obtaining a depth distance includes using the sensor to obtain the depth distance of the plurality of regions on at least a portion of the person.

18. The method of claim 1, wherein obtaining the depth distance between each region in a plurality of regions includes obtaining at least some of the depth distances from a face of a person.

19. The method of claim 1, wherein obtaining the depth distance between each region in a plurality of regions includes obtaining at least some of the depth distances from a head of a person.

20. The method of claim 1, wherein the step of determining an identification feature of at least a portion of the object includes identifying that a face is in a scene that is being viewed by a sensor for measuring the depth distances.

21. The method of claim 1, wherein the step of determining an identification feature of at least a portion of the object includes recognizing at least a portion of a face of a person in order to be able to uniquely identify the person.

22. The method of claim 21, wherein the step of determining an identification feature of at least a portion of the object includes determining an identity of the person by recognizing at least a portion of the face of the person.

23. The method of claim 21, wherein recognizing at least a portion of a face of a person includes classifying the object as the person, and detecting the face from other body parts of the person.

24. The method of claim 1, wherein the step of obtaining a depth distance between each region in a plurality of regions includes passively measuring the depth distances using a depth perceptive sensor.

25. The method of claim 24, wherein the step of determining an identification feature of at least a portion of the object includes authenticating a person.

26. The method of claim 25, further comprising authorizing the person to perform an action after authorizing the person.

27. The method of claim 25, further comprising permitting the person to enter a secured area after authorizing the person.

28. A method for classifying one or more objects that are present in a monitored area, the method comprising:
measuring a depth distance between each region in a plurality of regions on a surface of each of the one or more objects and a reference; and
identifying one or more features of each of the one or more objects using the depth distance of one or more regions in the plurality of regions; and
classifying each of the one or more objects individually based on the one or more identified features.

29. The method of claim 28, wherein measuring a depth distance between each region in a plurality of regions on a surface of the one or more objects and a reference includes capturing a depth image of each of the one or more objects.

30. The method of claim 28, wherein classifying each of the one or more objects based on the one or more identified features includes classifying each of the one or more objects as at least one of a person, an infant, a pet, or a child seat.

31. A method for controlling access to a secured area, the method comprising:
detecting a person positioned within a scene associated with the secured area;
capturing one or more depth images of at least a portion of the person; and
determining whether to grant the person access to the secured area based on the depth image.

32. The method of claim 31, wherein the step of detecting a person and capturing one or more images are performed passively, such that no action other than the person's presence in the monitored region is necessary to perform the steps.

33. The method of claim 31, wherein capturing a depth image of a portion of the person includes capturing the depth image of at least a portion of the person's face.

34. The method of claim 31, wherein determining whether to grant the person access includes recognizing the person from the depth image.

35. The method of claim 34, wherein recognizing the person includes recognizing at least a portion of a face of the person.

36. The method of claim 34, wherein recognizing the person from the depth image includes determining an identity of the person.

37. The method of claim 34, wherein recognizing the person from the depth image includes recognizing that the person is of a class of people that is granted access to the given area.

37. The method of claim 34, wherein recognizing the person from the depth image includes determining an identity of the person, and using the identity to perform the step of determining whether to grant the person access to the given area.

39. A method for recognizing an object, the method comprising:
obtaining a depth distance between each region in a plurality of regions on a surface of the object and a reference; and
using the depth distances to identify a set of features from the object that are sufficient to uniquely identify the object from a class that includes a plurality of members.

40. The method of claim 39, further comprising determining an identity of the object based on the depth distances between the regions on the surface.

41. The method of claim 38, wherein the object corresponds to a person, and wherein the step of using the depth distances to identify a set of features includes using the depth distances to recognize features on the person's body.

42. The method of claim 41, wherein the step of using the depth distances to identify a set of features includes using the depth distances to recognize one or more identifying features on the person's face.

43. The method of claim 42, further comprising matching the one or more identifying features of the person's face to one or more corresponding features of a known face associated with a person having a particular identity.

44. The method of claim 42, further comprising authenticating the person based on the one or more identifying features of the person's face.

45. The method of claim 42, further comprising authorizing the person to perform a given action based on the one or more identifying features of the person's face
